(19) United States
(12) Patent Application Publication
(10) Pub. No.: US 2026/0346287 A1
(43) Pub. Date: Nov. 5, 2026

(54) IRRIGATION SPRINKLER WATER PRESSURE SENSING

(71) Applicant: IrriGreen, Inc., Edina, MN (US)

(72) Inventors: Ted M. Hoffman, Eden Prairie, MN (US); Evan Pastor, Plymouth, MN (US)

(21) Appl. No.: 19/194,609

(22) Filed: Apr. 30, 2025

(51) Int. Cl. B05B 12/00; A01G 25/16; B05B 3/04; B05B 15/74

(52) U.S. Cl. CPC B05B 12/008; A01G 25/16; B05B 15/74; B05B 3/04

(57) ABSTRACT

An irrigation sprinkler includes a base having a main chamber and an input port configured to receive a flow of water, a valve, a pressure sensor and a nozzle head. The valve includes a valve housing having an inlet that is fluidically connected to the input port and an outlet, a valve body contained within an interior cavity of the valve housing and a motor configured to drive movement of the valve body between open and closed positions. The pressure sensor is exposed to a pressure within the interior cavity that is fluidically connected to the input port when the valve body is in the open position and is fluidically disconnected from the input port when the valve body is in the closed position. The nozzle head is configured to discharge water received through input port and the fluid flow path.

### FIELD

Embodiments of the invention relate to irrigation sprinklers and, more particularly, to sensing a water pressure in an irrigation sprinkler.

### BACKGROUND

“Smart” irrigation sprinklers, such as those developed and produced by Irrigreen, Inc. of Edina, Minnesota, operate to water a predefined area having a non-circular perimeter. As a result, the smart irrigation sprinklers can target areas that require watering (e.g., grass, shrubs, etc.) while avoiding areas that should not be watered (e.g., sidewalk, driveway, house, landscape, etc.). Examples of such sprinklers are described in U.S. Pat. Nos. 9,643,196 and 10,232,395, and PCT Publication No. PCT/US2022/035994, which are incorporated herein by reference in their entirety.

Such smart irrigation sprinklers control the watering of the non-circular predefined area by adjusting a distance a watering stream is discharged from a nozzle head of the sprinkler based on an angular position of the head using. This water stream distance is controlled using a valve of the sprinkler based on a sensed pressure of the water flow through the sprinkler. As a result, the accuracy at which the sprinkler can water the predefined area is substantially determined based on the accuracy of the water pressure estimate.

### SUMMARY

Embodiments of the present disclosure relate to pressure sensing in an irrigation sprinkler and include irrigation sprinklers having a pressure sensor, methods of operating the irrigation sprinklers and methods of assembling the irrigation sprinklers.

One example of the irrigation sprinkler includes a base having a main chamber and an input port configured to receive a flow of water, a valve contained in the main chamber, a pressure sensor supported within the main chamber and a nozzle head. The valve includes a valve housing, a valve body and a motor. The valve housing includes an inlet that is fluidically connected to the input port, an outlet and an interior cavity. The valve body is contained within the interior cavity. The motor is configured to drive movement of the valve body between a closed position, in which a fluid flow path extending between the inlet and the outlet is blocked by the valve body, and an open position, in which the fluid flow path is open between the inlet and the outlet. The pressure sensor is exposed to a pressure within the interior cavity that is fluidically connected to the input port when the valve body is in the open position and is fluidically disconnected from the input port when the valve body is in the closed position. The nozzle head is configured to discharge water received through input port and the fluid flow path.

In one embodiment, the pressure sensor is exposed to the pressure through a port extending through the valve housing.

In one embodiment, the valve body is a ball valve body having a fluid pathway and the fluid flow path extends through the fluid pathway when the valve body is in the open position.

In one embodiment, the sprinkler includes an O-ring surrounding one of the inlet and the outlet through which the fluid flow path extends, and engagement between an exterior of the valve body and the O-ring seals the corresponding inlet or outlet when the valve body is in the closed position.

In one embodiment, the O-ring surrounds the inlet.

In one embodiment, the base includes a bottom portion of the valve housing comprising the inlet and a lower interior wall that surrounds a bottom portion of the valve body and defines a bottom portion of the interior cavity. A top portion of the valve housing is mounted to the bottom portion of the valve housing and includes the outlet and an upper interior wall that surrounds a top portion of the valve body and defines a top portion of the interior cavity. A seal formed between the bottom and top portions of the valve housing.

In one embodiment, the sensor port extends through the upper interior wall.

In one embodiment, the motor is attached to the top portion of the valve housing.

In one embodiment, the sprinkler includes a cap attached to a top of the base that seals the main chamber.

In one embodiment, the sprinkler includes a riser post supporting the nozzle head and having an inlet that is fluidically coupled to the outlet of the valve housing, the riser post configured to move between a lowered position and a raised position.

In one example of a method of assembling a sprinkler, a base is provided having a main chamber, an input port, and a bottom portion of a valve housing having an inlet that is fluidically coupled to the input port. A valve assembly is provided that includes a top portion of the valve housing having an outlet, a valve body, a motor attached to the top portion and configured to move the valve body between open and closed positions relative to the top portion, and a pressure sensor attached to the top portion. The valve assembly is installed in the main chamber including mounting the top portion to the bottom portion, such that the valve body is contained within an interior cavity of the valve housing formed between the bottom and top portions. A nozzle head is installed in fluidic communication with the outlet of the valve housing. A fluid flow path extending between the inlet to the outlet is blocked by the valve body when the valve body is in the closed position. The fluid flow path is open between the inlet and the outlet when the valve body is in the open position. The pressure sensor is exposed to a pressure within a portion of the interior cavity that is fluidically connected to the input port when the valve body is in the open position and is fluidically disconnected from the input port when the valve body is in the closed position.

In one embodiment, the pressure sensor is exposed to the pressure within the fluid cavity through a port extending through the top portion of the valve housing.

In one embodiment, the valve body is a ball valve body having a fluid pathway and the fluid flow path extends through the fluid pathway when the valve body is in the open position.

In one embodiment, the method includes surrounding the inlet with an O-ring through which the fluid flow path extends, engagement between the exterior of the valve body and the O-ring seals the inlet when the valve body is in the closed position.

In one example of a method of operating a sprinkler, the sprinkler includes a base having a main chamber and an input port that is connected to a source of water, a valve contained in the main chamber, a pressure sensor and a nozzle head. The valve includes a valve housing, a valve body and a motor. The valve housing includes an inlet that is fluidically connected to the input port, an outlet and an interior cavity. The valve body is contained within the interior cavity. The motor is configured to move a position of the valve body between a closed position, in which a fluid flow path extending between the inlet and the outlet is blocked by the valve body, and an open position, in which the fluid flow path is open between the inlet and the outlet. The pressure sensor is supported within the main chamber and exposed to a pressure within the interior cavity that is fluidically connected to the input port when the valve body is in the open position, and is fluidically disconnected from the input port when the valve body is in the closed position. The nozzle head is supported by the base configured to discharge water received through the input port and the fluid flow path. In the method, which is performed by a controller, the position of the valve body is transitioned from the closed position to the open position using the motor. The pressure is sensed using the pressure sensor. The motor is controlled to adjust the position of the valve body based on the sensed pressure.

In one embodiment, the pressure sensor is exposed to the pressure within the fluid cavity through a port extending through the valve housing.

In one embodiment, the method includes: sensing the pressure using the pressure sensor while transitioning the position of the valve body from the closed position toward the open position using the motor; detecting a step change in the sensed pressure caused by a flow of water entering the fluid flow path and the interior cavity; identifying a first position of the valve body corresponding to the detection of the step change in the sensed pressure; and storing the first position in memory.

In one embodiment, the method includes: retrieving a second position from the memory; comparing the first position to the second position; and issuing a warning when a difference between the first and second positions exceeds a threshold value.

In one embodiment, the sprinkler includes an O-ring surrounding the inlet, and engagement between an exterior of the valve body and the O-ring seals the inlet when the valve body is in the closed position.

In one embodiment, the valve housing includes a top portion and a bottom portion. The sprinkler includes a valve assembly that includes the top portion, the motor attached to the top portion, the valve body attached to the top portion, and pressure sensor attached to the top portion. The base includes the bottom portion of the valve housing.

This Summary is provided to introduce a selection of concepts in a simplified form that are further described below in the Detailed Description. This Summary is not indented to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a schematic diagram of an example of an irrigation sprinkler, in accordance with embodiments of the present disclosure

FIGS. 2 and 3 are isometric views of an example of an in-ground version of the sprinkler, in accordance with embodiments of the present disclosure.

FIG. 4 is a side cross-sectional view of the example sprinkler of FIG. 2 taken generally along line 4-4, in accordance with embodiments of the present disclosure.

FIGS. 5 and 6 respectively are an exploded isometric and assembled cross-sectional isometric views illustrating components of an example sprinkler that may be contained in a main chamber of a base, in accordance with embodiments of the present disclosure.

FIG. 7-9 are side cross-sectional views of the components shown in FIGS. 5 and 6 including a valve respectively in a closed position, an intermediary position, and an open position, in accordance with embodiments of the present disclosure.

FIG. 10 is a simplified diagram of an example of a controller, in accordance with embodiments of the present disclosure.

### DETAILED DESCRIPTION OF ILLUSTRATIVE EMBODIMENTS

Embodiments of the present disclosure, which are described more fully hereinafter with reference to the accompanying drawings, relate to pressure sensing in an irrigation sprinkler and include irrigation sprinklers having a pressure sensor, methods of operating the irrigation sprinklers and methods of assembling the irrigation sprinklers. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

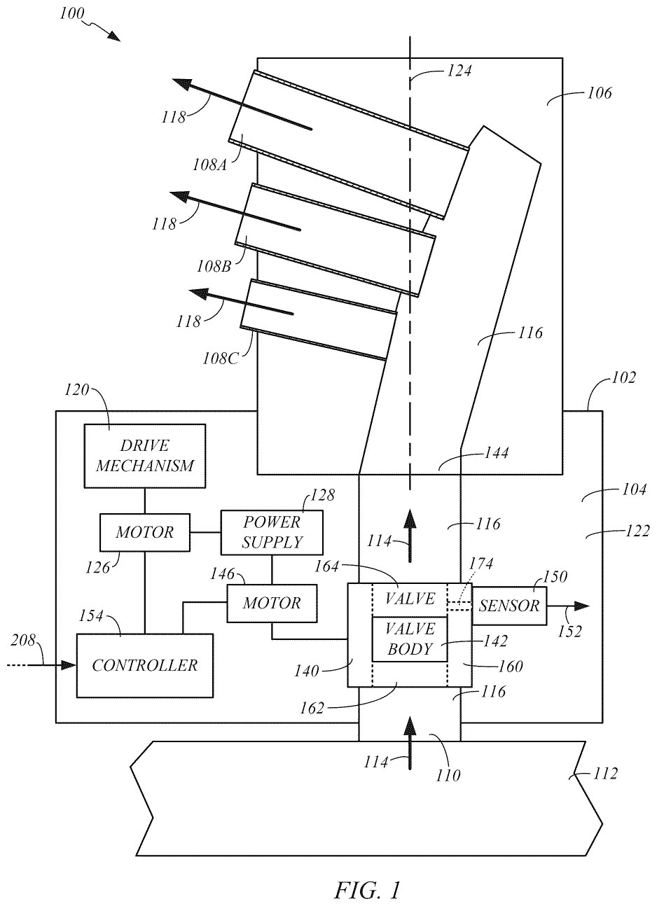

FIG. 1 is a schematic diagram of an example of an irrigation sprinkler 100, in accordance with embodiments of the present disclosure. The example sprinkler 100 generally comprises a housing 102 including a base 104, which supports a nozzle head 106 that includes one or more nozzles 108, such as nozzles 108A-C.

The base 104 includes a water supply input port 110 that may be coupled to a water supply line 112, such as a hose or in-ground piping. The water supply line 112 provides a pressurized source of water that supplies a water flow 114 to the nozzles 108 through a fluid flow path 116 of the sprinkler 100 that extends from the input port 110 to the nozzle head 106 where the water flow 114 is discharged through the one or more nozzles 108 as one or more watering streams 118.

In one embodiment, the sprinkler 100 includes a drive mechanism 120 supported within a main chamber 122 of the base 104 that is configured to drive rotation of the nozzle head 102 about a vertical axis 124 relative to the base 104, in accordance with conventional sprinklers. In one example, the drive mechanism 120 comprises a motor 126, such as an electric motor (e.g., stepper motor, or a motor with an encoder) or a hydraulic motor that drives the rotation of the nozzle head 102 relative to the base 104 through a suitable gear arrangement. The motor 126 may be powered using a suitable power source 128, such as a battery or line power received from a main control box through a power line, for example.

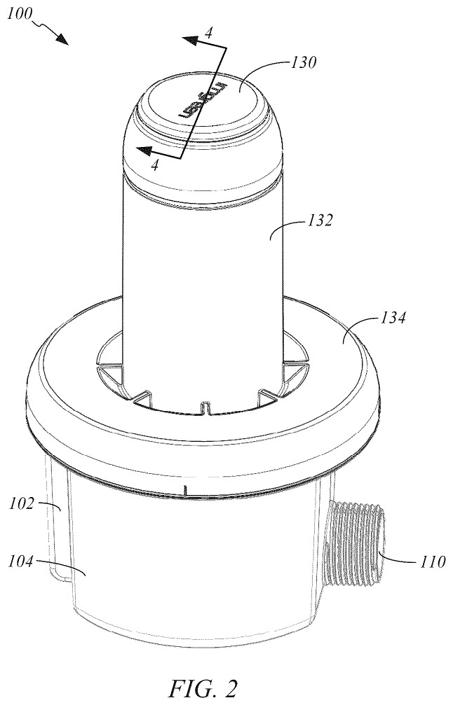

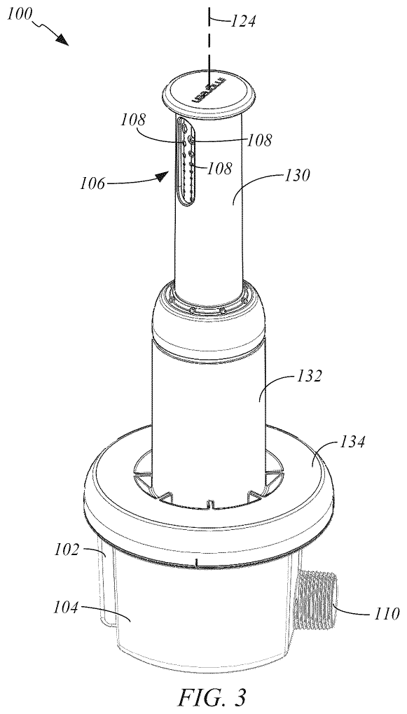

The sprinkler 100 may be designed for use as an in-ground sprinkler, in which the housing 102 may be buried within the ground. FIGS. 2 and 3 are isometric views of an example of an in-ground version of the sprinkler 100, in accordance with embodiments of the present disclosure. The nozzle head 106 may be supported on a rotatable riser post 130 having a lowered position, in which the riser post 130 is retracted into a pedestal 132 of the housing 102 that is supported by the base 104, as shown in FIG. 2, and a raised position, in which the riser post 130 is generally extended from the pedestal 132 for performing a watering operation, as shown in FIG. 3. The pedestal 132 may be supported by a cap 134 that seals an opening to the main chamber 122 of the base 104.

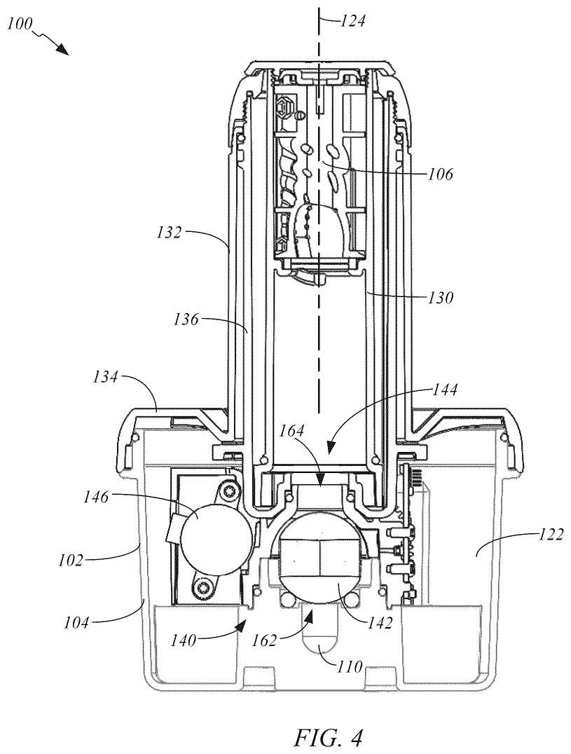

FIG. 4 is a side cross-sectional view of the example sprinkler 100 of FIG. 2 taken generally along line 4-4, in accordance with embodiments of the present disclosure. The riser post 130 may be supported within a rotatable support 136 that may be rotated about the central axis 124 using the drive mechanism 120 (FIG. 1), which drives rotation of the riser post 130 about the axis 124.

In one embodiment, the sprinkler 100 includes a valve 140 within the main chamber 122 that controls the water flow 114 through the fluid flow path 116 to the nozzle head 106, as shown in FIG. 1. The valve 140 may take on any suitable form, such as a ball valve, a solenoid valve, or another suitable form. In one embodiment, the valve 140 includes a valve body 142 having a closed position, in which water is blocked by the valve 140 from flowing through the fluid flow path 116 to the nozzle head 106, and an open position, in which the water flow 114 travels through the valve 140 and the fluid flow path 116 to an inlet 144 of the riser post 130.

For the in-ground sprinkler 100, when the valve 140 is open, the water flow 114 drives movement of the riser post 130 along the central axis 124 relative to the rotatable support 136 and the pedestal 132 to the raised position (FIG. 3) and is delivered to the nozzle head 106 where it is discharged through the one or more nozzles 108 as water streams 118 in a radial direction relative to the central axis 124. When the valve 140 is closed, the inlet 144 to the riser post 130 is fluidically disconnected from the input port 110, which terminates the water flow 114 through the fluid flow path 116. The resulting lack of water pressure at the inlet 144 causes the riser post 130 to return to the lowered position (FIG. 2), which may be driven using a suitable biasing mechanism, such as a spring.

The valve body 142 also includes intermediary positions between the fully opened and fully closed positions that allow the flow rate of the water flow 114 through the fluid flow path 116 to be adjusted. As a result, the valve 140 may be used to adjust the flow rate of the water flow 114 and the distance the water streams 118 are discharged from the nozzle head 106. The position of the valve body 142 may be controlled by an electric motor 146. The motor 146 may be a stepper motor, a motor with an encoder, a servo motor, or another suitable electric motor or device that may be used to adjust the position of the valve body 142.

In some embodiments, the sprinkler 100 includes a pressure sensor 150 that senses or measures a pressure within the fluid flow pathway 114 and produces a pressure signal 152 that is representative of the sensed pressure. A controller 154 of the sprinkler 100, which may be contained in the main chamber 122, uses the pressure signal 152 to set the position of the valve body 142 such that the water streams 118 are discharged from the nozzle head 106 a desired distance for a given angular position of the nozzle head 106 about the central axis. This allows the sprinkler 100 to discharge the water streams 118 a variable distance as the nozzle head 106 is rotated about the axis 124 and perform a watering operation over a non-circular watering area.

The accuracy at which the controller 154 may control the distance the one or more water streams 118 travel from the nozzle head 106 depends on the accuracy of the sensed pressure indicated by the pressure signal 152. The pressure sensor 150 is typically exposed to the fluid flow path 116 in which the water flow 114 travels. Turbulence in the water flow 114 may adversely affect the accuracy of the pressure measurement, which can lead to errors in the positioning of the valve body 142. Such valve position errors result in the water streams 118 being discharged from the nozzle head 106 distances that are either too short and do not reach a perimeter boundary of the predefined watering area or too long and extend past the perimeter boundary and into designated non-watering areas.

Some embodiments of the present disclosure operate to improve the accuracy of the pressure sensing of the water flow 114 through the fluid flow path 116 by the pressure sensor 150 by reducing the impact that turbulence in the water flow 114 may have on the sensed pressure. Additionally, embodiments of the present disclosure operate to simplify manufacturing of the sprinkler 100, allow for diagnostics to be performed on the valve 140, and provide other advantages and improvements over conventional irrigation sprinklers.

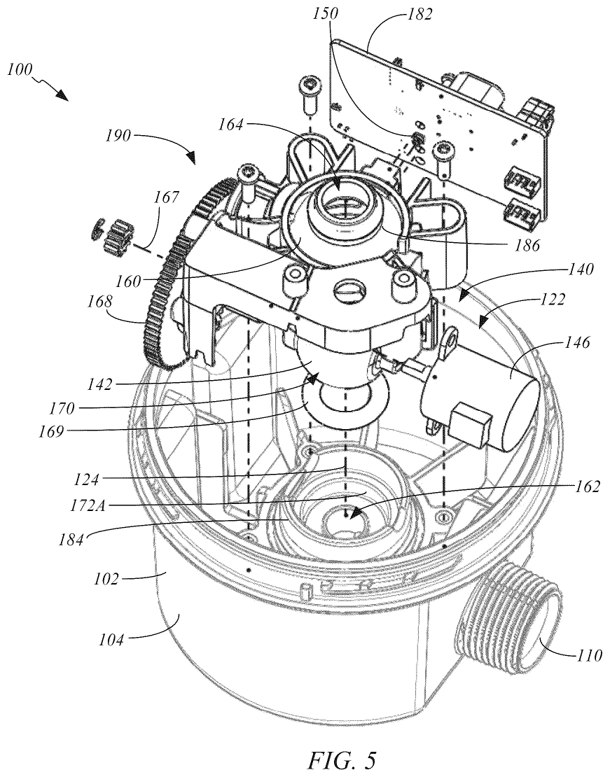

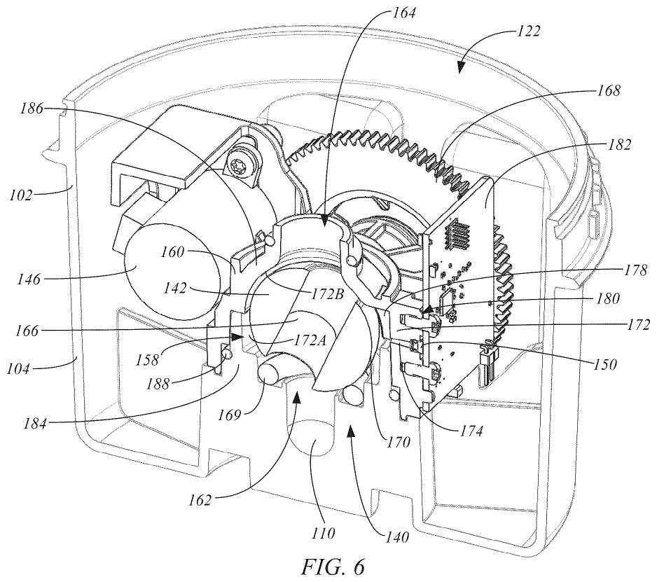

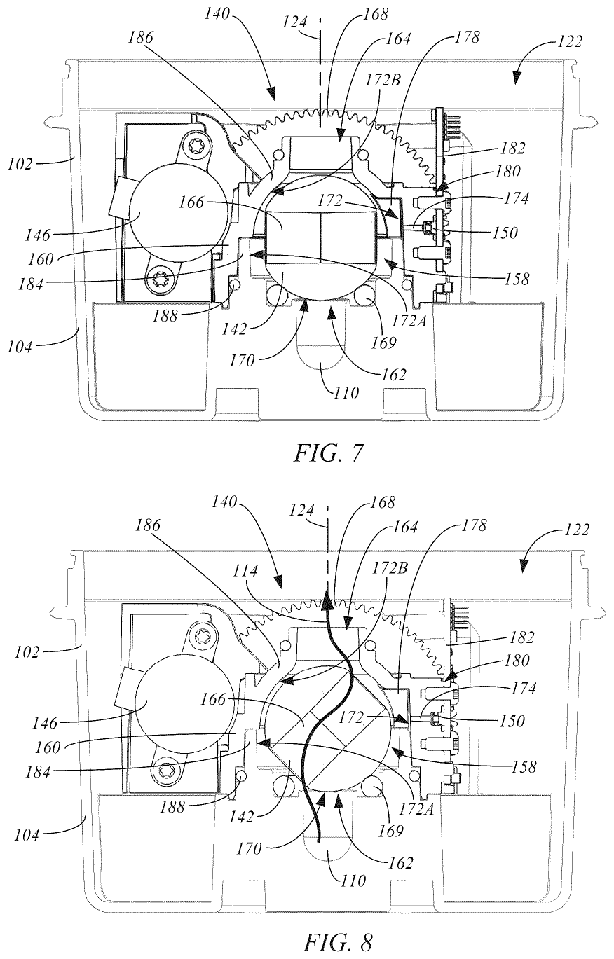

FIGS. 5 and 6 respectively are an exploded isometric and assembled cross-sectional isometric views illustrating components of the example sprinkler 100 that may be contained in the main chamber 122 of the base, such as the valve 140, in accordance with embodiments of the present disclosure. FIG. 7-9 are side cross-sectional views of the components of FIGS. 5 and 6 with the valve 140 respectively in a closed position, an intermediary position, and an open position, in accordance with embodiments of the present disclosure.

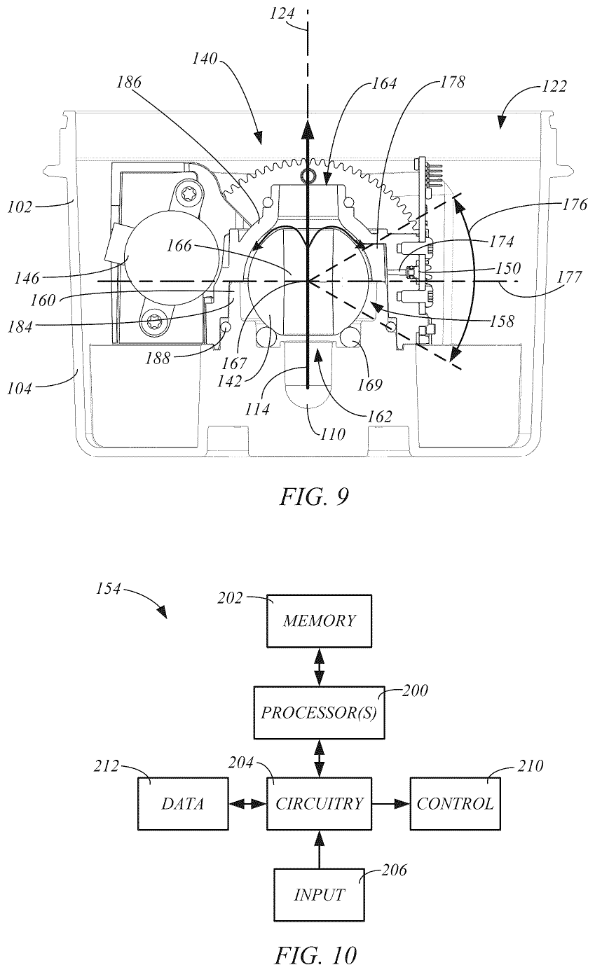

In some embodiments, the valve body 142 of the valve 140 is contained within an interior cavity 158 of a valve housing 160. The valve housing 160 includes an inlet 162 and an outlet 164 that provide access to the interior cavity 158. The inlet 162 is fluidically connected to the input port 110, and the outlet 164 is fluidically connected to the inlet 144 of the riser post 130 (FIG. 4). As mentioned above, the position of the valve body 142 may be changed using the motor 146 to transition the valve body 142 and the valve 140 between the closed position (FIG. 7) and open position (FIG. 9), as well as intermediary positions (FIG. 8) to vary a constriction to the fluid flow path 116 and control a flow rate at which a water flow 114 may travel through the valve 140 and the fluid flow path 116 and the distance the water streams 118 are discharged from the nozzle head 106.

In one example, the valve body 142 is a ball valve body having a fluid pathway 166 (e.g., bore) and the motor 146 may drive rotation of the valve body 142 about an axis 167 through one or more gears 168 between the open and closed positions, as shown in FIG. 5. When the valve body 142 is in the closed position (FIG. 7), the inlet 162 is fluidically disconnected from the outlet 164, and when the valve body 142 is in the open position (FIG. 9), the inlet 162 is fluidically connected to the outlet 164 through the fluid pathway 166.

In one embodiment, a seal is formed at the inlet 162 and/or the outlet 164 when the valve body 142 is in the closed position to block the water flow 114. In one embodiment, the seal at the inlet 162 is formed using an O-ring 169 that surrounds the inlet 162. When the valve body 142 is in the closed position, an exterior surface 170 of the valve body 142 engages the O-ring 169 and seals the inlet 162 to fluidically disconnect the inlet 162 and the outlet 164 and close the valve 140, as shown in FIG. 7. An O-ring may also be similarly situated at the outlet to seal the outlet with the exterior 170 of the valve body 142 to close the valve 140. In one embodiment, only the O-ring 169 is used to seal the inlet 162 and the outlet 164 is not sealed using a similar O-ring at the outlet 164, as shown in FIG. 7.

When the valve body 142 is rotated about the axis 167 (FIG. 5) relative to the valve housing to the open position (FIGS. 8 and 9), the seal at the inlet 162 and/or the outlet 164 is broken by the fluid pathway 166 through the valve body 142. Thus, the water flow 114 travels through the fluid flow path 116, which extends from the input port 110 to the inlet 162, through the fluid pathway 166 and the outlet 164 of the valve body 142, as indicated in FIGS. 8 and 9. Thus, the water flow 114 is delivered to the inlet 144 of the riser post 130 and discharged through the nozzle head 106 (FIG. 1).

In some embodiments, the interior cavity 158 of the valve housing 160 is fluidically coupled to the fluid flow path 116 and the input port 110 when the valve 140 is in the open state, as indicated in FIG. 9. The pressure sensor 150, which is contained in the main chamber 122, is exposed to and configured to sense a pressure within the interior cavity 158 between the valve body 142 and an interior wall 172 (FIG. 8) of the valve housing 160. In one embodiment, the pressure sensor 150 is configured to sense the pressure through a sensor port 174 that extends through the valve housing 160, for example. A suitable seal is formed to prevent water from leaking through the sensor port 174.

In some embodiments, the sensor port 174 is substantially shielded from the turbulent water flow 114 traveling through the fluid flow pathway 116 between the inlet 162 and the outlet 164 while still being exposed to the pressure within the fluid flow pathway 116 due to the interior cavity 158 being filled with water and in fluid communication with the fluid flow pathway 116 and the input port 110. As a result, the pressure at the location of the sensor port 174 is substantially more stable than a location within the turbulent water flow 114. This allows for more stable and accurate line pressure measurements by the sensor 150.

In one embodiment, pressure sensed by the sensor 150 may be shielded from the turbulent water flow 114 by the valve body 142, narrow gaps between the interior wall 172 and the exterior 170 of the valve body 142 extending from the inlet 162 and the outlet 164, and/or the sensor port 174. In one embodiment, the sensor port 174 is located withing an angle range 176 from a plane 177 extending perpendicularly to the central axis 124 and through the rotational axis 167 of the valve body of approximately 45 to −45 degrees, about 30 to −30 degrees, as indicated in FIG. 9, to shield the sensor port 174 and the location of the pressure sensed by the sensor 50 from the turbulence of the water flow 114.

In some embodiments, the interior cavity 158 includes a recessed pressure cavity 178 that is defined by a recessed section of the interior wall 172 of the valve housing 160, and the sensor port 174 extends through the interior wall 172 to the pressure cavity 178, as shown in FIGS. 6 and 7. The pressure cavity 178 creates additional shielding of the location of the pressure sensed by the sensor 50 from the turbulence of the water flow 114.

The pressure sensor 150 may be mounted to an exterior 180 of the valve housing 160. In one embodiment, the pressure sensor 150 is mounted to a circuit board 182 that is attached to the exterior 180 of the valve housing 160, as shown in FIG. 5-7. The circuit board 182 may include the controller 154 and/or circuitry for controlling the motor 146, processing the pressure signal 152, and/or performing other functions, for example.

In one embodiment, the valve housing 160 includes a bottom portion 184, which includes the inlet 162, and a top portion 186, which includes the outlet 164. The bottom portion 184 and the top portion 186 are assembled to form the valve housing 160 and a junction between the bottom and top portions may be sealed using a suitable technique, such as an O-ring 188, as shown in FIG. 6. An interior wall 172A of the bottom portion 184 and an interior wall 172B of the top portion 186 define the interior cavity 158, in which the valve body 142 is contained. In one embodiment, the bottom portion 184 is integrated with the base 104, which eliminates a potential leak path within the fluid flow path 116 from the input port 110 to the inlet 162 of the valve housing 160.

The pressure sensor 150 and the circuit board 182 may be attached to the top portion 186 of the valve housing 160 as shown in FIGS. 6 and 7. Thus, in some embodiments, the sensor port 174 extends through the top portion 186 and the interior wall 172B, and the recessed pressure cavity 178 may be formed by the top portion 186 and the interior wall 172B.

In one embodiment, the sprinkler 100 includes a valve assembly 190 comprising the top portion 186 to which one or more of the motor 146, the gear 168, the valve body 142, the circuit board 182 and the pressure sensor 150 are attached, as indicated in FIG. 5. The valve assembly 190 simplifies the assembly of the sprinkler 100. For example, one may assemble the sprinkler 100 by placing the O-ring 169 around the inlet 162 of the bottom portion 184, placing the O-ring 188 around the bottom portion 184 (see, e.g., FIG. 6), installing the valve assembly 190 on the bottom portion 184 and securing the valve assembly 190 and the top portion 186 to the bottom portion 184, such as using suitable connectors (e.g., screws) or through the compression of the assembly 190 against the bottom portion 184 using the rotatable support 136 and the cap 134 (see, e.g., FIG. 4).

The controller 154 may represent one or more controllers and/or circuitry that is used to perform functions described herein. The controller 154 may be contained within the main chamber 122 of the base 104 or located remotely from the sprinkler 100.

FIG. 10 is a simplified diagram of an example of the controller 154 in accordance with embodiments of the present disclosure. The controller 154 may include one or more processors 200 and memory 202, which may be local memory or memory that is accessible to the controller 154. The one or more processors 200 are configured to perform various functions described herein in response to the execution of instructions contained in the memory 202, such as a test program, for example.

The one or more processors 200 may be components of one or more computer-based systems, and may include one or more control circuits, microprocessor-based engine control systems, and/or one or more programmable hardware components, such as a field programmable gate array (FPGA). The memory 202 represents local and/or remote memory or computer-readable media. As used herein, such memory 202 comprises any suitable patent subject matter eligible computer-readable media and does not include transitory waves or signals. Examples of the memory 202 include conventional data storage devices, such as hard disks, CD-ROMs, optical storage devices, magnetic storage devices and/or other suitable data storage devices. The controller 154 may include circuitry 204 for use by the one or more processors 200 to receive input signals 206, such as control signals 208 (FIG. 1) from a central controller, issue control signals 210 (e.g., motor control signals) and/or communicate data 212, such as in response to the execution of the instructions stored in the memory 202 by the one or more processors 200.

The controller 154 may control a watering operation based on the pressure signal 152 and an angular position of the nozzle head 106 about the central axis 124, such as in response to the execution of instructions stored in the memory 202 or other memory. The angular position of the nozzle head 106 may be determined, for example, using an encoder that is connected to the drive mechanism 120.

In one example, the controller 154 may start a watering operation by opening the valve 140 using the motor 146. A mapping stored in the memory 202 may link the angular position of the nozzle head to a desired pressure, which corresponds to a desired flow rate of the water flow 114 and a distance the water streams 118 are discharged from the nozzle head 106 such that they reach a perimeter boundary of a predefined watering area, for example. Thus, the controller 154 may adjust the position of the valve body 142 using the motor 146 based on the pressure signal 152 until the corresponding value matches the desired pressure for the angular position of the nozzle head 106. The process may continue for different angular positions of the nozzle head 106 to perform a watering operation over the predefined watering area.

In one embodiment, the controller 154 performs diagnostics on the valve 140, such as to detect a malfunction of the valve 140 or a condition of the valve 140. In one example, the controller 154 monitors the pressure signal 152 to sense the pressure while transitioning the position of the valve body 142 from the closed position toward the open position using the motor 146. At the moment when the valve body 142 no longer fluidically disconnects the inlet 162 from the outlet 164, such as when the seal between the exterior 170 of the valve body 142 and the O-ring 169 is broken, there will be a step change in the pressure indicated by the pressure signal 152 due to the water flow 114 through the valve 140. The controller 154 detects this step change in the sensed pressure and identifies the position of the valve body 142 corresponding to the occurrence of the step change using, for example an encoder, and stores the value in the memory 202. This process may occur at the time of manufacture through a calibration routine, or after the sprinkler is initially installed, for example.

Periodically, the controller 154 may repeat the process to identify the position at which the step change in the sensed pressure occurs and compare the new value corresponding to the newly identified position of the valve body 142 to that stored in the memory 202. A difference between the values may indicate a malfunction (e.g., a blockage) and/or a deteriorating condition of the valve 140 (e.g., valve body, O-ring, etc.). In one embodiment, if the difference between the values exceeds a threshold, the controller 154 may issue a warning (e.g., alarm, notification, etc.) indicating that the valve 140 should be inspected.

Although the present invention has been described with reference to preferred embodiments, workers skilled in the art will recognize that changes may be made in form and detail without departing from the spirit and scope of the invention.

What is claimed is:

1. An irrigation sprinkler comprising:
a base having a main chamber and an input port configured to receive a flow of water;
a valve contained in the main chamber and comprising:
a valve housing having an inlet that is fluidically connected to the input port, an outlet and an interior cavity;
a valve body contained within the interior cavity; and
a motor configured to drive movement of the valve body between a closed position, in which a fluid flow path extending between the inlet and the outlet is blocked by the valve body, and an open position, in which the fluid flow path is open between the inlet and the outlet;
a pressure sensor supported within the main chamber and exposed to a pressure within the interior cavity that is fluidically connected to the input port when the valve body is in the open position, and is fluidically disconnected from the input port when the valve body is in the closed position; and
a nozzle head configured to discharge water received through input port and the fluid flow path.

2. The irrigation sprinkler according to claim 1, wherein the pressure sensor is exposed to the pressure through a sensor port extending through the valve housing.

3. The irrigation sprinkler according to claim 1, wherein:
the valve body is a ball valve body having a fluid pathway; and
the fluid flow path extends through the fluid pathway when the valve body is in the open position.

4. The irrigation sprinkler according to claim 1, wherein:
the sprinkler includes an O-ring surrounding one of the inlet and the outlet through which the fluid flow path extends; and
engagement between an exterior of the valve body and the O-ring seals the corresponding inlet or outlet when the valve body is in the closed position.

5. The irrigation sprinkler according to claim 4, wherein the O-ring surrounds the inlet.

6. The irrigation sprinkler according to claim 2, wherein:
the base includes a bottom portion of the valve housing comprising the inlet and a lower interior wall that surrounds a bottom portion of the valve body and defines a bottom portion of the interior cavity;
a top portion of the valve housing is mounted to the bottom portion of the valve housing and includes the outlet and an upper interior wall that surrounds a top portion of the valve body and defines a top portion of the interior cavity; and
a seal formed between the bottom and top portions of the valve housing.

7. The irrigation sprinkler according to claim 6, wherein the sensor port extends through the upper interior wall.

8. The irrigation sprinkler according to claim 7, wherein the motor is attached to the top portion of the valve housing.

9. The irrigation sprinkler according to claim 8, including a cap attached to a top of the base that seals the main chamber.

10. The irrigation sprinkler according to claim 9, including a riser post supporting the nozzle head and having an inlet that is fluidically coupled to the outlet of the valve housing, the riser post configured to move between a lowered position and a raised position.

11. A method of assembling a sprinkler comprising:
providing a base having a main chamber, an input port, and a bottom portion of a valve housing having an inlet that is fluidically coupled to the input port;
providing a valve assembly comprising:
a top portion of the valve housing having an outlet;
a valve body;
a motor attached to the top portion and configured to move the valve body between open and closed positions relative to the top portion; and
a pressure sensor attached to the top portion;
installing the valve assembly in the main chamber comprising mounting the top portion to the bottom portion, such that the valve body is contained within an interior cavity of the valve housing formed between the bottom and top portions; and
installing a nozzle head in fluidic communication with the outlet of the valve housing,
wherein:
a fluid flow path extending between the inlet to the outlet is blocked by the valve body when the valve body is in the closed position;
the fluid flow path is open between the inlet and the outlet when the valve body is in the open position; and
the pressure sensor is exposed to a pressure within a portion of the interior cavity that is fluidically connected to the input port when the valve body is in the open position and is fluidically disconnected from the input port when the valve body is in the closed position.

12. The method according to claim 11, wherein the pressure sensor is exposed to the pressure within the fluid cavity through a sensor port extending through the top portion of the valve housing.

13. The method according to claim 11, wherein:
the valve body is a ball valve body having a fluid pathway; and
the fluid flow path extends through the fluid pathway when the valve body is in the open position.

14. The method according to claim 11, wherein:
the method includes surrounding the inlet with an O-ring through which the fluid flow path extends; and
engagement between the exterior of the valve body and the O-ring seals the inlet when the valve body is in the closed position.

15. A method of operating a sprinkler, which comprises:
a base having a main chamber and an input port that is connected to a source of water;
a valve contained in the main chamber and comprising:
a valve housing having an inlet that is fluidically connected to the input port, an outlet and an interior cavity;
a valve body contained within the interior cavity; and
a motor configured to move a position of the valve body between a closed position, in which a fluid flow path extending between the inlet and the outlet is blocked by the valve body, and an open position, in which the fluid flow path is open between the inlet and the outlet;
a pressure sensor supported within the main chamber and exposed to a pressure within the interior cavity that is fluidically connected to the input port when the valve body is in the open position, and is fluidically disconnected from the input port when the valve body is in the closed position; and
a nozzle head supported by the base configured to discharge water received through the input port and the fluid flow path, the method, which is performed by a controller, comprising:
transitioning the position of the valve body from the closed position to the open position using the motor;
sensing the pressure using the pressure sensor; and
controlling motor to adjust the position of the valve body based on the sensed pressure.

16. The method according to claim 15, wherein the pressure sensor is exposed to the pressure within the fluid cavity through a sensor port extending through the valve housing.

17. The method according to claim 15, including:
sensing the pressure using the pressure sensor while transitioning the position of the valve body from the closed position toward the open position using the motor;
detecting a step change in the sensed pressure caused by a flow of water entering the fluid flow path and the interior cavity;
identifying a first position of the valve body corresponding to the detection of the step change in the sensed pressure; and
storing the first position in memory.

18. The method according to claim 15, including:
retrieving a second position from the memory;
comparing the first position to the second position; and
issuing a warning when a difference between the first and second positions exceeds a threshold value.

19. The method according to claim 15, wherein:
the sprinkler includes an O-ring surrounding the inlet; and
engagement between an exterior of the valve body and the O-ring seals the inlet when the valve body is in the closed position.

20. The method according to claim 15, wherein:
the valve housing includes a top portion and a bottom portion;
the sprinkler includes a valve assembly comprising:
the top portion;
the motor attached to the top portion;
the valve body attached to the top portion; and
the pressure sensor attached to the top portion; and
the base includes the bottom portion of the valve housing.
